(19) United States
(12) Patent Application Publication
(10) Pub. No.: US 2008/0046488 A1
(43) Pub. Date: Feb. 21, 2008

(54) Populating a database

(76) Inventor: Michael Lawrence Woodley, Cambridge (GB)

Correspondence Address: JAMES C. WRAY, 1493 CHAIN BRIDGE ROAD, SUITE 300, MCLEAN, VA, 22101, US

(21) Appl. No.: 11/634,492

(22) Filed: Dec. 6, 2006

(30) Foreign Application Priority Data
Aug. 17, 2006 (GB) 06 16 368.7

(51) Int. Cl. G06F 17/30

(52) U.S. Cl. 707/206

(57) ABSTRACT

A method of populating a database of textural representations of spoken dialogue forming part of a video asset. The method comprises the steps of playing a recording of the video asset that includes graphical subtitles; converting the graphical subtitles into a plurality of text strings; and storing each of the text strings in combination with a representation of the position of the originating dialogue in the asset.

### CROSS REFERENCE TO RELATED APPLICATION

This application claims priority from United Kingdom Patent Application No. 06 16 368.7, filed 17 Aug. 2006, the disclosure of which is incorporated herein by reference in its entirety.

### TECHNICAL FIELD

The present invention relates to populating databases of video assets.

### BACKGROUND OF THE INVENTION

There are many situations in which it is desirable to search through video assets (whereby video includes any recorded moving pictures such as film and computer graphics etc). Because the spoken dialogue of a video asset is recorded as sound, it is not readily searchable. There are many environments in which it advantageous to facilitate a search of the spoken dialogue of a video asset. These environments include research, archiving, entertainment and retail etc.

### BRIEF SUMMARY OF THE INVENTION

According to an aspect of the present invention, there is provided a method of populating a database of textural representations of spoken dialogue forming part of a video asset, comprising the steps of: playing a recording of the video asset that includes graphical subtitles; converting said graphical subtitles into a plurality of text strings; and storing each of said text strings in combination with a representation of the position of the originating dialogue in the asset.

### BRIEF DESCRIPTION OF THE SEVERAL VIEWS OF THE DRAWINGS

FIG. 1 shows an example of an environment in which the present invention can be utilised;

FIG. 2 shows details of processing system 101 shown in FIG. 1;

FIG. 3 shows steps undertaken in an example of the present invention;

FIG. 4 shows the table which forms part of an example of a database created at step 303;

FIG. 5 shows an example of a further table created at step 303;

FIG. 6 shows the relationship between table 401 and table 501;

FIG. 7 shows details of step 305 from FIG. 3;

FIG. 8 shows the procedure of populating the database with film information;

FIG. 9 shows an expansion of step 703 from FIG. 7;

FIG. 10 shows an expansion of step 905 from FIG. 9;

FIG. 11 shows an expansion of step 1005 from FIG. 10;

FIG. 12 shows an expansion of step 1105 from FIG. 11;

FIG. 13 shows an example of software performing the step of prompting a user for input at step 1203;

FIG. 14 shows an example of a text file generated as a result of step 905;

FIG. 15 shows an expansion of step 704 from FIG. 7;

FIG. 16 shows an expansion of step 1503 from FIG. 15;

FIG. 17 shoes an expansion of step 1504 from FIG. 15;

FIG. 18 shows an example of a table which has been populated;

FIG. 19 shows an expansion of step 307 from FIG. 3; and

FIG. 20 shows the results of the process described with reference to FIG. 19.

### DESCRIPTION OF THE BEST MODE FOR CARRYING OUT THE INVENTION

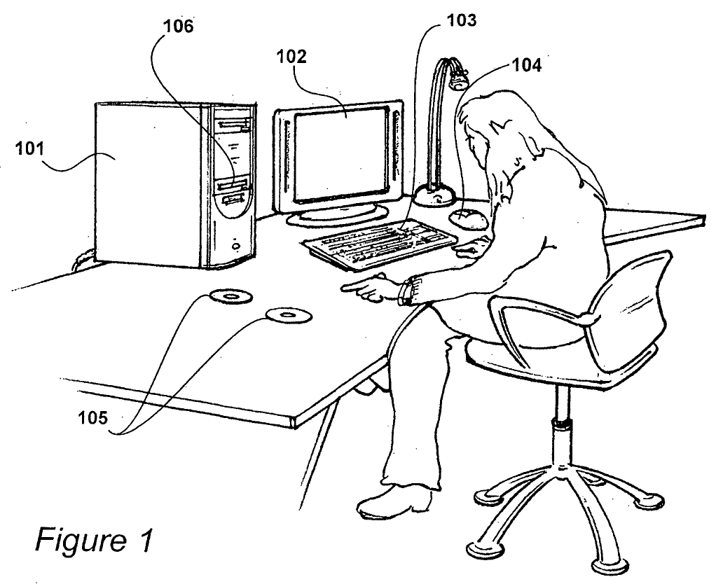

### FIG. 1

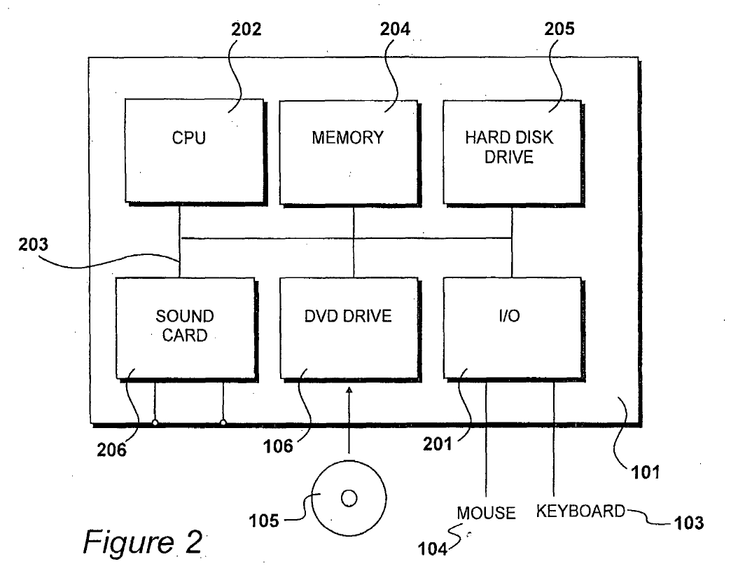

An example of an environment in which the present invention can be utilised is illustrated in FIG. 1. A processing system 101 (further detailed in FIG. 2) is configured to display output to a monitor 102, and to receive input from devices such as keyboard 103 and mouse 104 etc. A plurality of DVDs 105 provide data and instructions to processing system 101 via a DVD drive 106.

In this example, video assets are stored on DVDs 105. An operator wishes to search the video assets for a specific phrase of spoken dialogue. In order to achieve this search operation, the present invention populates a database with information.

### FIG. 2

Details of processing system 101 are shown in FIG. 2. A DVD such as 105 is insertable into DVD drive 106. Keyboard 103 and mouse 104 communicate with a serial bus interface 201. A central processing unit (CPU) 202 fetches and executes instructions and manipulates data. CPU 202 is connected to system bus 203. Memory is provided at 204. A hard disk drive 205 provides non-volatile bulk storage of instructions and data. Memory 204 and hard disk drive 205 are also connected to system bus 203. Sound card 206 receives sound information from CPU 202 via system bus 203. Data and instructions from DVD drive 106 and input/output bus 201 are transmitted to CPU 202 via system bus 203.

While the system illustrated in FIG. 2 is an example of components which can be used to implement the invention, it should be appreciated that any standard personal computer could be used.

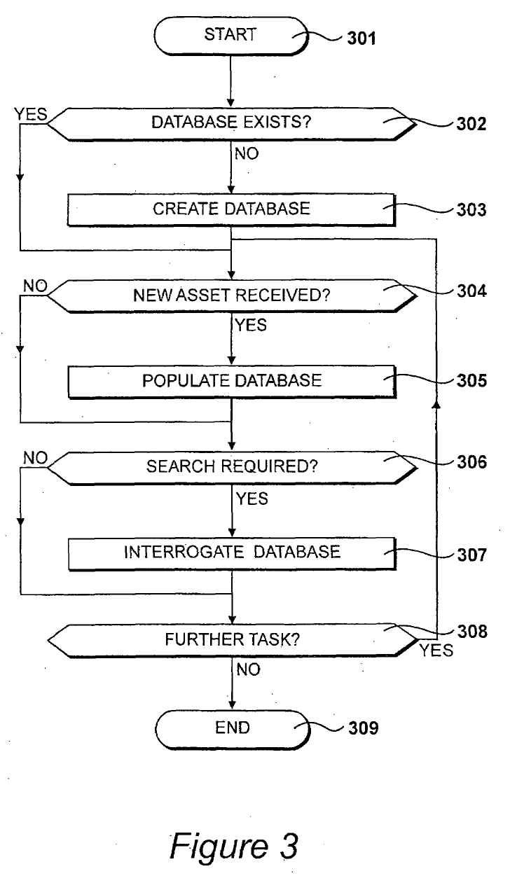

### FIG. 3

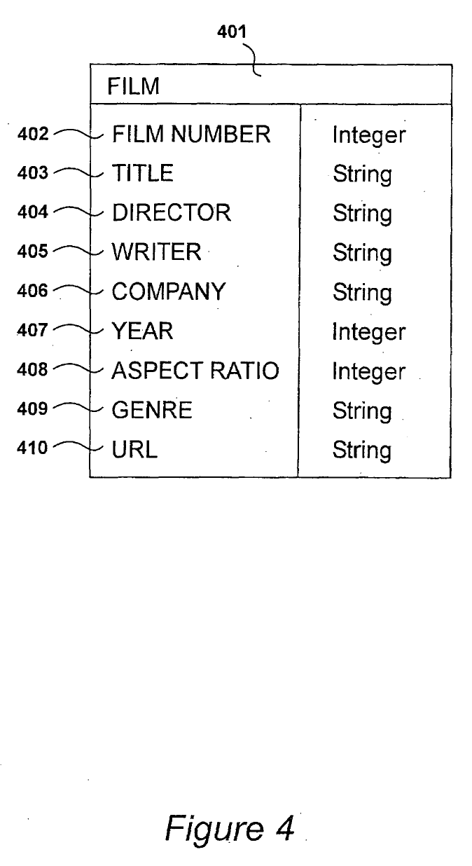

Steps undertaken in an example of the present invention are shown in FIG. 3. The procedure starts at 301, and at 302 a question is asked as to whether a database exists. If the question asked at 302 is answered in the negative, indicating that a database does not exist then a database is created at 303. This is further illustrated with reference to FIGS. 4, 5 and 6.

If the question asked at 302 is answered in the affirmative, indicating that a database does exist then step 303 is omitted.

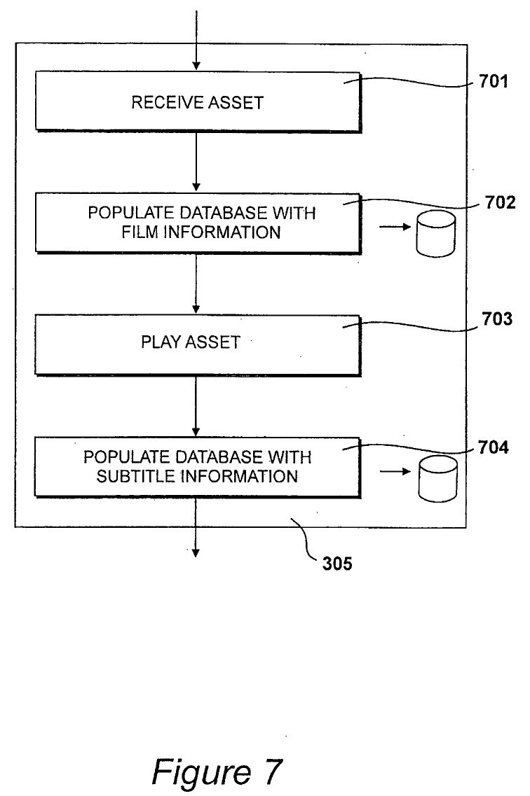

At 304 a question is asked as to whether a new asset has been received. If this question is answered in the affirmative then the database is populated at 305. This is further described with reference to FIGS. 7, 8, 9, 10, 11, 12, 13, 14, 15, 16, 17 and 18. If the question asked at 304 is answered in the negative then step 305 is omitted.

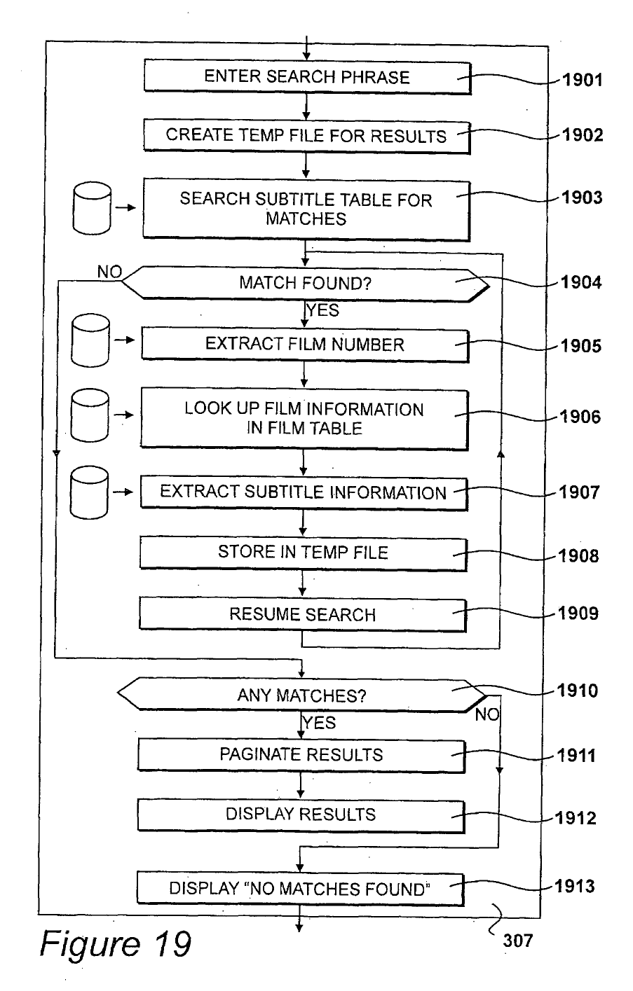

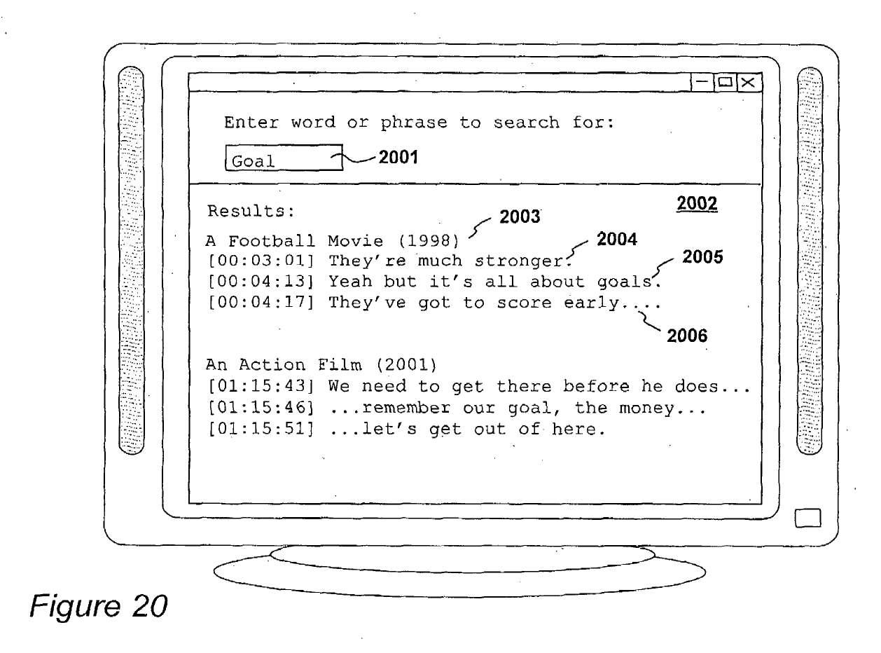

At 306 a question is asked as to whether a search is required. If this question is answered in the affirmative then the database is interrogated at 307. This is further illustrated with reference to FIGS. 19 and 20. If the question asked at 306 is answered in the negative, step 307 is omitted.

At step 308 a question is asked as to whether a further task is required. If this is answered in the affirmative then proceedings loop back to 304. If the question asked at 308 is answered in the negative then the procedure ends at 309.

FIG. 3 illustrates three distinct procedures involved with the database in this example, namely creation, population and interrogation. Creation of the database, in this example occurs once (although in certain circumstances a created database may need to be amended). Populating the database occurs incrementally when assets are received. In this example a large number of assets are indexed initially and further assets can be added later on. The third stage, interrogating the database, can occur as soon as a database has been created and has been populated with some data. The querying stage is likely to be repeated many times.

Step 303, creation of the database, will now be described in further detail with reference to FIGS. 4, 5 and 6.

### FIG. 4

A table which forms part of an example of a database created at step 303 is shown in FIG. 4. In this example, the video assets to be indexed are feature films (movies). In alternative embodiments, the video assets could be television programmes, computer graphics sequences, or any other video asset.

A table 401 is created to store film data. A first field 402 is created to store a unique identifier for a film (a film number). This is stored as an integer. A second field 403 stores the film title as a string of characters. Field 404 stores the name of the film director as a string of characters and field 405 stores the writer's name as a string of characters. The production company's name is stored in field 406 as a string of characters, and the year of production is stored at 407 as an integer. At field 408 the aspect ratio of the film is stored as an integer and at 409 the film genre is stored as a string. At 410 a URL can be added to link, for example, to the film's website.

FIG. 4 is intended to illustrate examples of fields which could be included in such a table. Depending upon the exact database design and other requirements many more or different fields could be included.

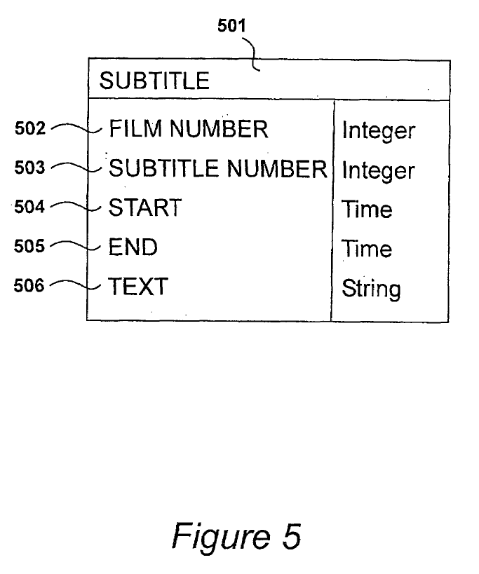

### FIG. 5

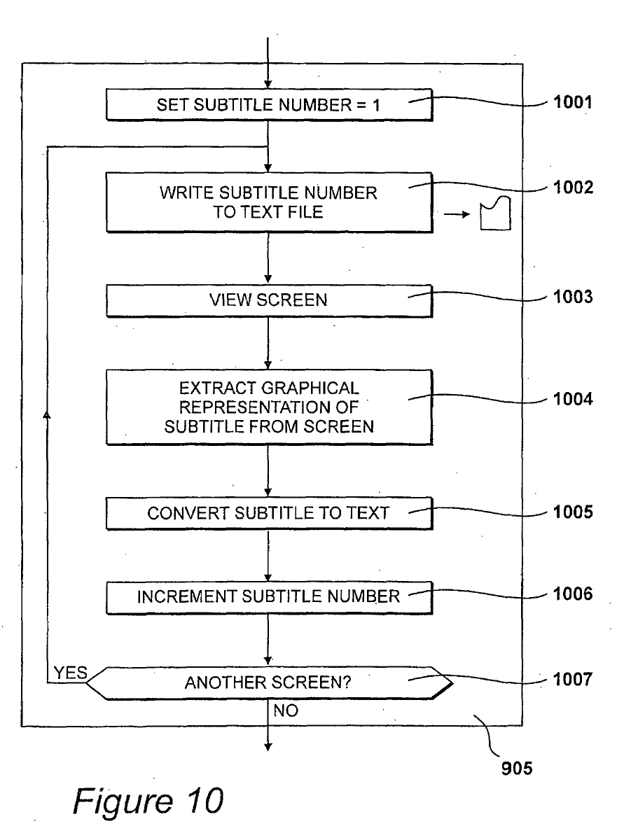

An example of a further table created at step 303 is illustrated in FIG. 5. Table 501 is created to store subtitle data. The database is to be searchable by phrases of spoken dialogue, and in this embodiment the dialogue is extracted from subtitles. When a video asset is stored on a DVD, subtitles are generally stored as sequential image bitmaps or similar graphical representations. When subtitles are switched on, they are rendered on top of the video display by the DVD player. Extraction of these subtitles is further described with reference to FIGS. 10, 11, 12, 13 and 14. Table 501 has, in this example, five fields. Field 502 corresponds to field 402 in table 401 and stores the film number as an integer. Field 503 stores a number for each subtitle as an integer. Field 504 stores the start time at which that particular subtitle is to be displayed and field 505 stores the end time for the subtitles display. Finally, field 506 stores the actual text of the subtitle as a character string.

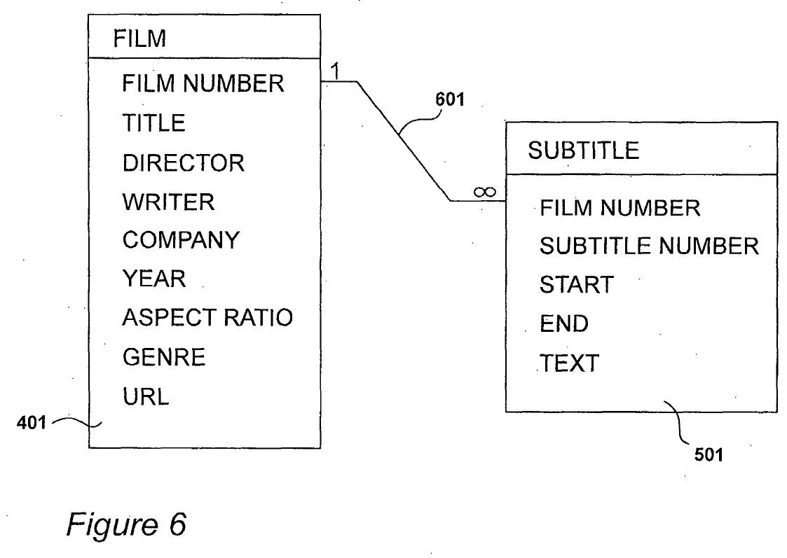

### FIG. 6

The relationship between table 401 and table 501 in this example is shown in FIG. 6. The field “film number” forms a bridge between the tables, and a one-to-many relationship exists as illustrated by link 601. This enables film information to be stored once and to be linked to many sets of subtitle information.

### FIG. 7

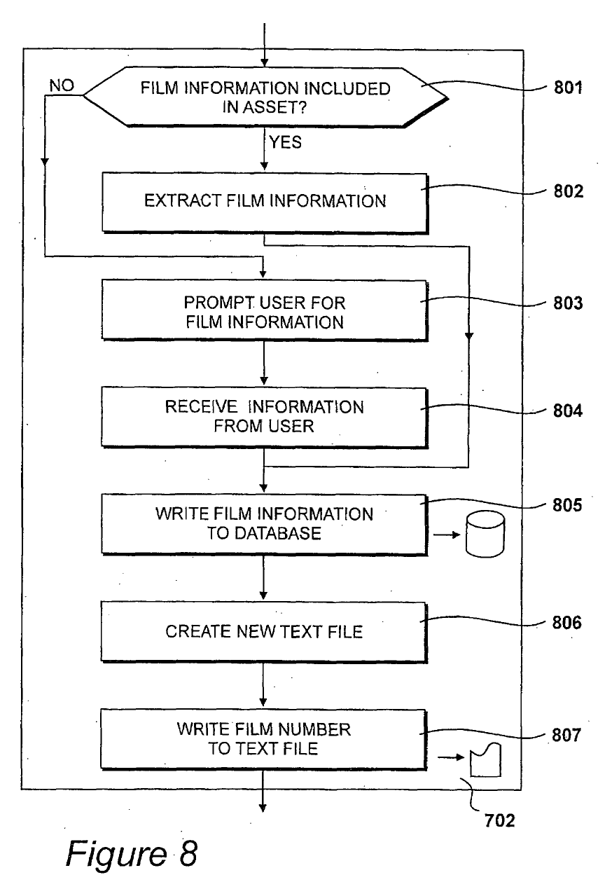

Details of step 305 from FIG. 3 are shown in FIG. 7. Once the database has been created as described with reference to step 303 and FIGS. 4, 5 and 6, data can be put into the database. At step 701 an asset is received which is to be added to the database. In this example, the asset is a film stored on a DVD. In alternative embodiments the asset may be received via a network such as the Internet or on some other storage medium. A first step in populating the database is populating it with film information at step 702. This is further described with reference to FIG. 8. Film information is only entered into the database once and the set of film information is linked with the sets of subtitled information by the inclusion of the film number in both tables.

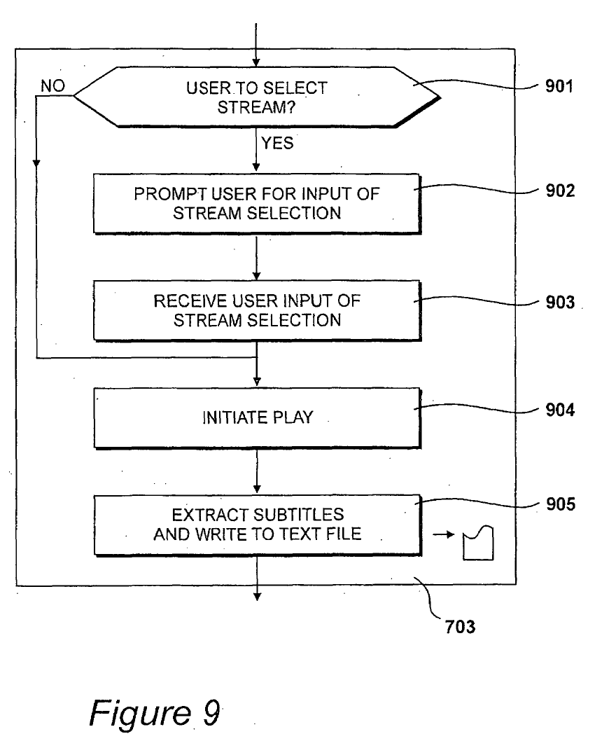

At step 703 the asset is played, as further detailed with reference to FIGS. 9, 10, 11, 12, 13 and 14.

Once the asset has been played and subtitles extracted at step 703, the database is populated with subtitle information at step 704.

The step of populating the database with film information at 702 will now be further described with reference to FIG. 8.

### FIG. 8

The procedure of populating the database with film information is shown in FIG. 8. Thus, the result of FIG. 8 is that the table defined in FIG. 4 has a value for each field.

At step 801, the question is asked as to whether film information is included in the asset. DVDs often include textural information such as that required to fill in the table 401. If this is the case the system will detect this at 801 and proceed to step 802 at which point the film information will be extracted. In contrast, if the film information is not included in the asset then the user is prompted to provide film information at step 803. Once information is received from the user at step 804 it is written to the database at step 805. In the present example, the film number is a number created for the purposes of the database. This is to ensure that each film has a unique identifier. Thus it may automatically be generated by the database or may be entered manually, but in either case it is not necesary to use any number which may be assigned to the film on the asset itself (such as a number or code identifying the film to the production company).

A new text file is created at 806 which will store the subtitled text once extracted. At 807 the film number is written to the text file to identify it. Thus, the result of the operation at 702 is that the film information is written to the database, a text file has been created with the film number in it and is ready to receive subtitle text.

### FIG. 9

Step 703, identified in FIG. 7, is detailed in FIG. 9. At step 901 a question is asked as to whether the user is to select the required stream. Many DVDs contain a variety of streams each containing subtitles of a different language. Thus, if desired, the user can be prompted for input of a stream selection at 902. If this is the case, then user input is received at 903. Alternatively, the stream can be automatically played. At 904 play is initiated. At 905, the subtitles are extracted and written to the text file which was created at 806. Step 905 is further detailed with reference to FIGS. 10, 11, 12, 13, 14, 15, 16, 17 and 18.

### FIG. 10

Step 905, identified in FIG. 9, is detailed in FIG. 10. Subtitles are saved as graphical representations (such as bitmaps, JPEGS etc) of screens. In this example, each screen is allocated a number, therefore each subtitle number refers to the text displayed on a screen at any one time, which may be one or more lines long.

At step 1001 a variable to represent subtitle number is set equal to one. This subtitle number is written to the text file at step 1002. At 1003 a screen is viewed and the graphical representation of the subtitles from this screen is extracted at 1004.

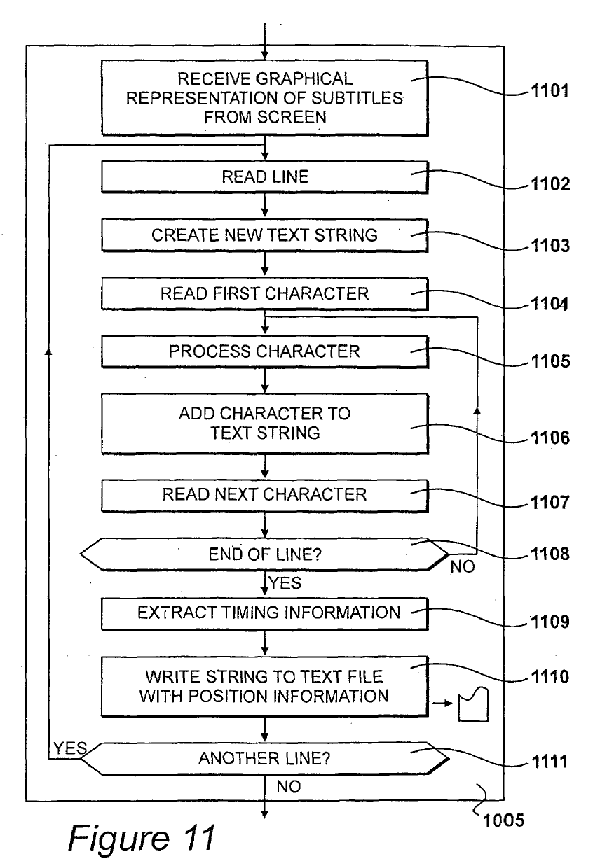

At 1005 the subtitle extracted at 1004 is converted to text. This is further described with reference to FIG. 11. Once this conversion has occurred, the subtitle number is incremented at 1006. A question is asked at 1007 as to whether there is another screen remaining in the asset. If this question is answered in the affirmative then the procedure resumes from step 1002. If the question asked at step 1007 is answered in the negative then the asset has finished playing and therefore the operation of step 703 is complete.

### FIG. 11

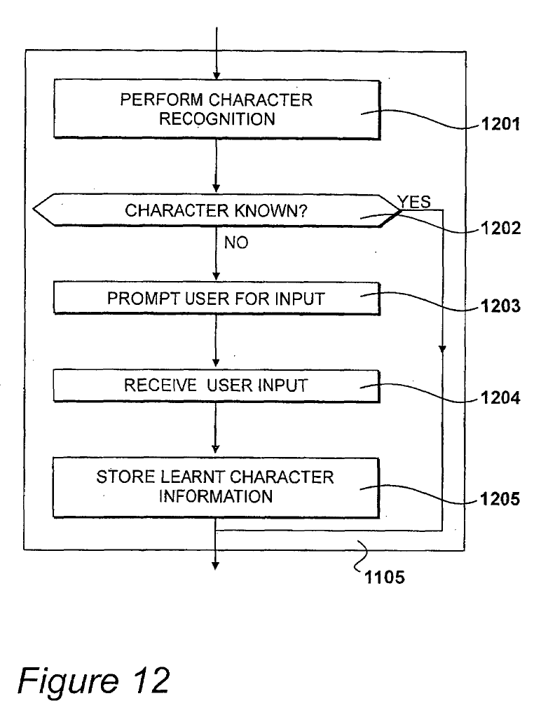

Procedures which take place at step 1005 in FIG. 10 are detailed in FIG. 11. At step 1101 a graphical representation of subtitles from a screen is received. At 1102 the first line of the subtitle is read. At 1103 a new text string is created which will contain the text corresponding with the line of the graphical representation which is read at 1102. At 1104 a first character is read. At 1105 the character is processed, this is further detailed with reference to FIG. 12. The output of the procedure 1105 is a text character which is added to the text string at 1106. The next character is then read at 1107 and at 1108 a question is asked as to whether the end of the line has been reached. The end of the line may be marked by a delimiter or the system may recognise that the end of the line has been reached by some other means such as detection of a series of spaces. If the question asked at 1108 is answered in the negative then there are further characters to process and the procedure resumes from 1105. If the question asked at 1108 is answered in the affirmative and the end of the line has been reached then timing information is extracted at 1109. In the present example, subtitles are stored together with information as to when they are to be displayed over the recording. This information is extracted at 1109.

At step 1110 the text string which has been generated by the preceding steps is written to the text file created at 806, along with position information extracted at 1109. At 1111 a question is asked as to whether another line is present as part of the current screen of subtitles. If this question is answered in the affirmative then proceedings resume from step 1102 and the next line is read. If the question asked at 1111 is answered in the negative and there are no further lines to process within the present screen then step 1005 is complete, as the entire screen of subtitles has been processed and written to the text file.

### FIG. 12

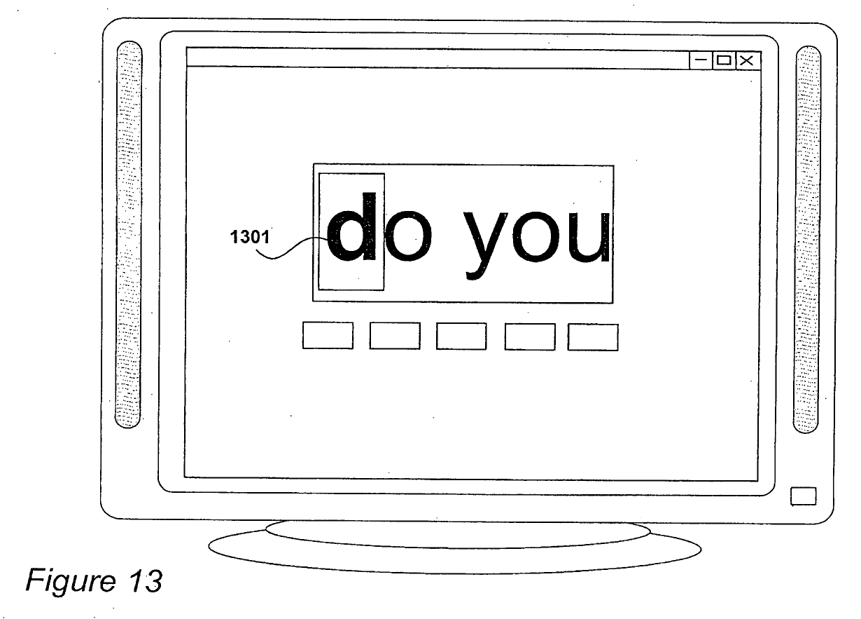

Procedures carried out at step 1105 identified in FIG. 11 are detailed in FIG. 12. At step 1105, the character is processed. The first stage is that character recognition is performed at 1201. In this example optical character recognition (OCR) is used, such as that undertaken by software such as the program SubRip™, however alternative packages can be used. At 1202 a question is asked as to whether the character is known. SubRip™ or an equivalent program contains a dictionary of known characters relating the graphical representations to text (ASCII) characters. Dictionaries are required for each different font which subtitles are presented in and it may be the case that the program comes across a character which is not in the dictionary. If this occurs, then the question asked at 1202 is answered in the negative and the user is prompted to provide input at 1203 as to what the character is. This is further described with reference to FIG. 13. User input providing information to identify the character is received at 1204. This information is added to the dictionary at 1205 such that it can be utilised when the program is run on subsequent occasions. If the character is known then the question at 1202 is answered in the affirmative and step 1105 is complete.

### FIG. 13

An example of software performing the step of prompting a user for input at step 1203 is shown in FIG. 13. The program looks at each character in turn and if it does not recognise a character, such as character 1301 then it requests user input to provide the character that corresponds to the graphical representation. Once the software has learnt the characters for a particular font, it then performs step 1105 without further prompting. This means that once the dictionary has been populated, the program is extremely efficient at extracting text from graphical subtitles. Thus, provided a given asset has subtitles in a known font, in the present embodiment text would “flash” across the screen as shown in FIG. 13 too quickly for a user to read it, as the OCR was taking place.

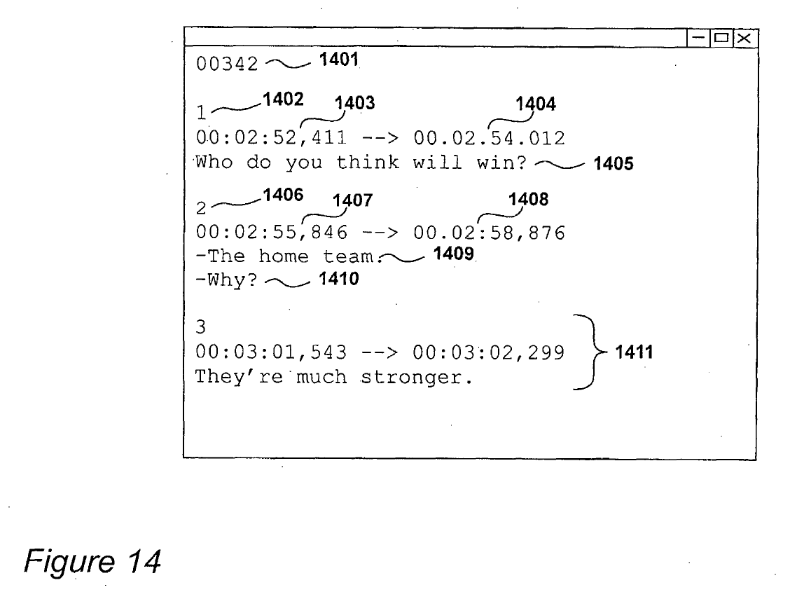

### FIG. 14

An example of a text file generated as a result of step 905 is shown in FIG. 14. The format shown in FIG. 14 is known as srt and is the recognised standard for subtitles. In alternative embodiments the subtitles may be stored in a different format. The film number is recorded at 1401 (this step is performed at 807). The first subtitle number (written to the text file at 1002) is shown at 1402. The start time 1403, end time 1404 and subtitle text 1405 are also shown, which are written to the text file at step 1110. Pieces of information 1402, 1403, 1404 and 1405 relate to a first screen of subtitles. A second screen of subtitles is shown below. Subtitle number 1406 is followed by start time 1407, end time 1408, a first line 1409 and second line 1410.

A third screen of subtitles is shown below at 1411. In this embodiment, the text file produced as shown in FIG. 14 undergoes error correction to remove standard OCR mistakes.

Thus a single text file is produced for each video asset, in this case for each film, which contains all the subtitles each indexed by their screen number and position information in the form of start and end times of display.

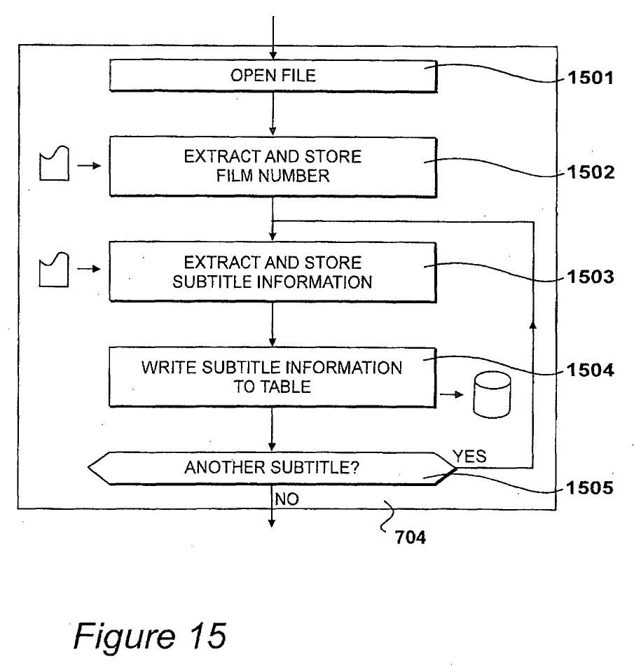

### FIG. 15

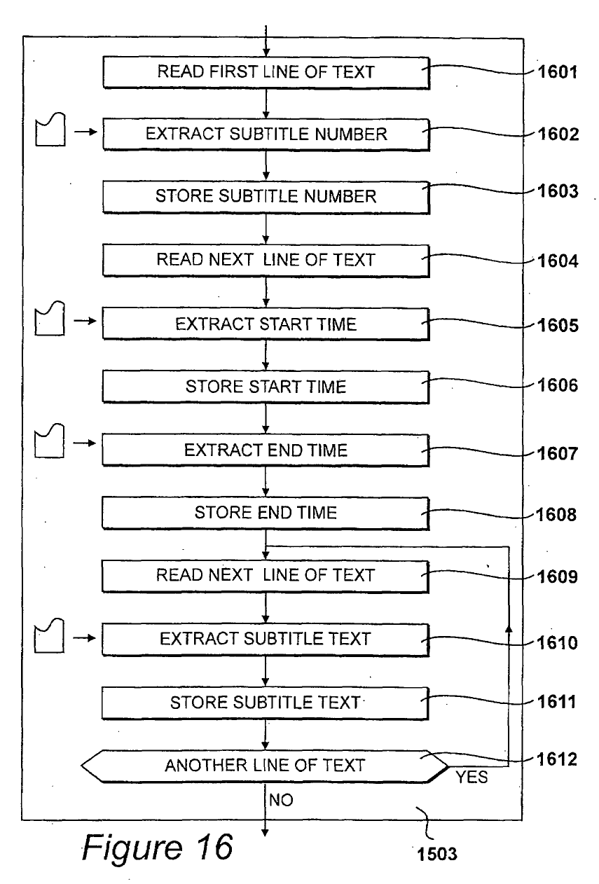

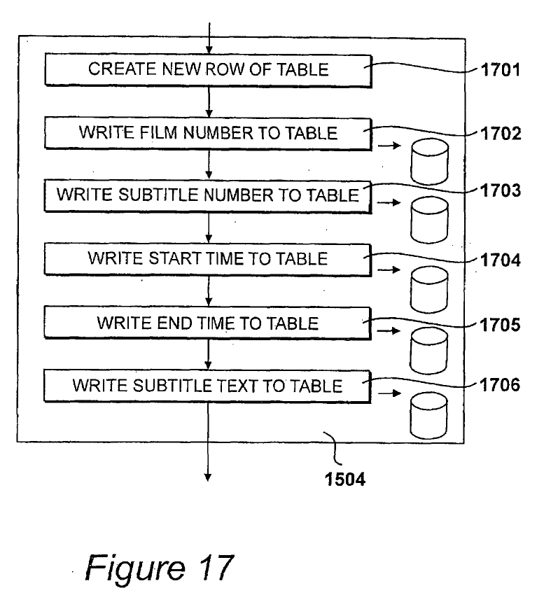

As previously described, the asset is played and subtitles extracted into a text file at step 703. At step 704, text is extracted from the text file and the database is populated with the subtitle information. This is further illustrated in FIG. 15. At 1501 the text file is opened and at 1502 the film number is extracted from the text file and stored locally. Referring to table 501 shown in FIG. 5 it can be seen that the film number must be stored with each separate subtitle therefore it is stored locally throughout the process of step 704 to avoid having to extract it from the text file multiple times. At step 1503 subtitle information is read and stored. This is further detailed in FIG. 16. At 1504 subtitle information is written to the table (table 501), as is further described with reference to FIG. 17. At step 1505 a question is asked as to whether there is another subtitle in the text file. If this question is answered in the affirmative, the process continues from step 503 when the subsequent subtitle is read and stored and then written to the table. This continues until all subtitles have been written to the table. If the question asked at 1505 is answered in the negative, indicating that all subtitles have been read from the text file and the database has been fully populated then step 704 is complete.

### FIG. 16

Step 1503 identified in FIG. 15 is detailed in FIG. 16. This procedure involves reading and storing subtitle information from the text file. At step 1601 the first line of text is read from the text file. This line contains the subtitle number as shown at 1402 in FIG. 14. Thus at 1602 the subtitle number is extracted and at 1603 it is stored locally.

The next line of text is read at 1604. This line contains the start time (shown at 1403 in FIG. 14) and the end time (shown at 1404 in FIG. 14). At step 1605 the start time is extracted and it is stored locally at step 1606. At step 1607 the end is extracted and this is stored locally at step 1608. Once the subtitle number and representation of position have been stored, the actual text of the subtitle must be extracted. At 1609 the next line of text (shown at 1405 in FIG. 14) is read and this is extracted at 1610. The subtitled text extracted is then stored locally at step 1611. At step 1612 a question is asked as to whether another line of text is present. If this question is answered in the affirmative then steps 1609, 1610 and 1611 are repeated such that the next line is read, extracted and stored. If the question asked at 1612 is answered in the negative thus indicating that there are no more lines of text then step 1503 is complete. Thus, the result of step 1503 is that all the information for one screen of subtitles has been extracted from the text file and stored locally. This is then ready to be written to the database, which is further described with reference to FIG. 17.

### FIG. 17

Procedures carried out during step 1504 as shown in FIG. 15 are detailed in FIG. 17. At 1701 a new row is created in the table (in this example table 501). A new row is required for each screen of subtitles. At 1702 the film number which was stored locally at step 1502 is written to the first column of the table. At step 1703 the subtitle number which was stored locally at step 1603 is written to the second column of the table. The start time which was stored locally at step 1606 is written to the table at step 1704. At step 1705 the end time which was stored locally at step 1608 is written to the table. At step 1706 the subtitle text which was stored locally at one or more executions of step 1611 is written to the table.

Thus as a result of step 1504 a row of the subtitle table (table 501) is populated with data relating to one screen of subtitles.

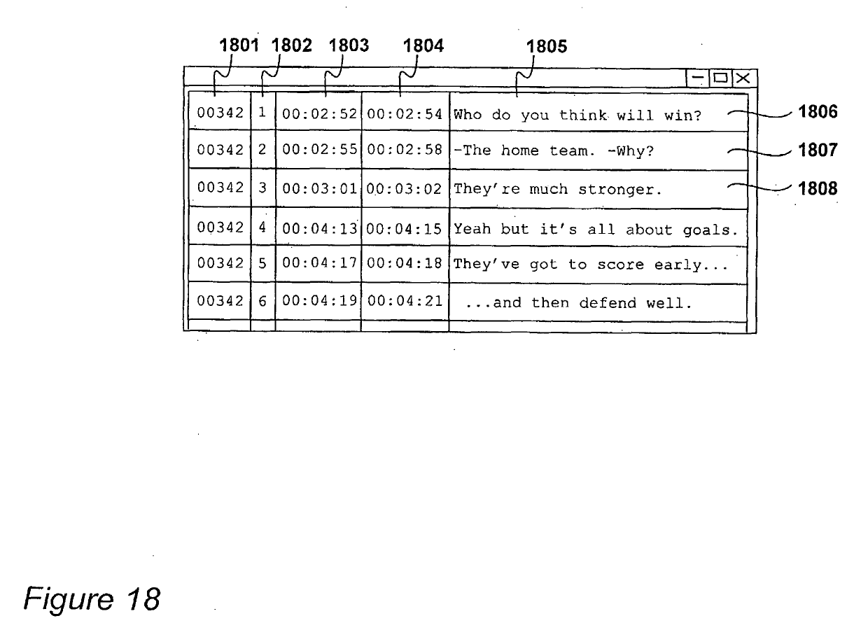

### FIG. 18

An example of a table such as table 501 which has been populated with subtitle information such as that shown in FIG. 14 is shown in FIG. 18. A first column 1801 contains the film number (shown at 1401). A second column 1802 shows the subtitle number, representing which screen of subtitles is present (as shown at 1402 and 1406). A third column 1803 shows the start time of when the subtitle is displayed on the screen in the original asset. This is shown in the text file at 1403. A fourth column 1804 shows the end time, as shown at 1404. The final column 1805 contains the subtitle text as shown at 1405, 1409 and 1410.

Each row such as rows 1806, 1807 and 1808 represents a screen of subtitles. In row 1807 it can be seen that subtitles shown as 1409 and 1410 in the text file in FIG. 14 which appear on different lines on the screen are concatenated into one row in the table. Each time step 1504 is undertaken a new row is created in the table.

### FIG. 19

As previously described, once the database has been populated at step 305 a search may be required. If this is the case then an appropriate query is generated and the database is interrogated at step 307 and this is further detailed in FIG. 19. At step 1901 a phrase is entered which is to be searched. Depending upon configuration of the database, the user may chose to search all assets or a subset. Choices may also be made relating to whether an exact match is required or whether any of the words in the search phrase are to be matched. At 1902 a temporary file is created for storing results.

The subtitle table (as shown in FIG. 18) is searched for instances of the search phrase at step 1903. In this example the search only looks for matches in column 1805 which contains the subtitled text. At step 1904 a question is asked as to whether a match has been found. If this question is answered in the affirmative then the film number is extracted from the matching line in the table. For example, if the text in column 1805 at row 1806 matches with the search phrase then the film number at column 1801 in row 1806 is extracted at 1905. At 1906 the film information for the film number extracted at 1905 is looked up from the film table. The subtitle information relating to the matched subtitle is extracted at 1907, in this example the subtitle in question is extracted along with the subtitle before and the subtitle after and their respective start times. The information relating to the film and the subtitles is written to the temporary file at 1908. At 1909 the search resumes to look for matches. If further instances of the search phrase are found then steps 1905, 1906, 1907, 1908 and 1909 are repeated as required. When the question asked at 1904 is answered in the negative, indicating that no further matches have been found a question is then asked at 1910 as to whether any matches were found. If this is answered in the affirmative then the results are paginated at 1911. In this example the preferences for pagination may be set by the user in advance, such as to display five results per page. The results are then displayed at 1912. Alternatively, if the question asked at 1910 is answered in the negative indicating that no matches have been found then a message to this effect is displayed at 1913. The results of this example search are displayed as shown in FIG. 20.

### FIG. 20

The results of the process described with reference to FIG. 19 are shown in FIG. 20. A search phrase is entered shown at 2001, as described with reference to step 1901 in FIG. 19. Search results are then displayed as described at step 1912 in FIG. 19, and this is shown at 2002. The film information such as title, date, director etc is displayed at 2003 followed by the subtitle lines 2004, 2005 and 2006 below. Each subtitle line also provides a representation of the position of the originating dialogue in the asset, in this example, in the form of the start time, when the phrase is displayed.

As well as facilitating an automatically generated query, in the present embodiment it is also possible to interrogate the database manually, for example using structured query language (SQL) queries etc.

1. A method of populating a database of textural representations of spoken dialogue forming part of a video asset, comprising the steps of:
playing a recording of the video asset that includes graphical subtitles;
converting said graphical subtitles into a plurality of text strings; and
storing each of said text strings in combination with a representation of the position of the originating dialogue in the asset.

2. A method according to claim 1, wherein said video asset is stored on a DVD.

3. A method according to claim 1, wherein said video asset is obtained from a network.

4. A method according to claim 3, wherein said network is the Internet.

5. A method according to claim 1, wherein said video asset is a film (movie).

6. A method according to claim 1, wherein said video asset is a television programme.

7. A method according to claim 1, wherein said graphical subtitles are stored as bitmaps.

8. A method according to claim 1, wherein said step of converting graphical subtitles into a plurality of text strings takes place by optical character recognition (OCR).

9. A method according to claim 1, further comprising the step of:
creating a database to store text strings in combination with a representation of the position of the originating dialogue in the asset.

10. A method according to claim 10, further comprising the steps of:
interrogating said database to find instances of a search phrase and their respective positions within the dialogue of said video asset; and
displaying said instances to a user.

11. A method according to claim 1, wherein said representation of the position of the originating dialogue in the asset is in the form of the time at which a given subtitle is displayed within said asset.

12. The method of populating a database of textural representations of spoken dialogue forming part of a video asset, comprising the steps of:
playing a recording of the video asset that includes graphical subtitles;
converting said graphical sub titles into a plurality of text strings by optical character recognition; and
storing each of said text strings in combination with the time at which a given subtitle is displayed within said assest.

13. A computer-readable medium having computer-readable instructions executable by a computer such that, when executing said instructions, a computer will perform the steps of:
playing a recording of the video asset that includes graphical sub-titles;
converting said graphical sub-titles into a plurality of text strings; and
storing each of said text strings in combination with a representation of the position of the originating dialogue in the asset.

14. A computer-readable medium having computer-readable instructions executable by a computer according to claim 13, wherein said video asset is a film (movie).

15. A computer-readable medium having computer-readable instructions executable by a computer according to claim 13, wherein said video asset is a television programme.

16. A computer-readable medium having computer-readable instructions executable by a computer according to claim 13, wherein said graphical subtitles are stored as bitmaps.

17. A computer-readable medium having computer-readable instructions executable by a computer according to claim 13, wherein said step of converting graphical subtitles into a plurality of text strings takes place by optical character recognition (OCR).

18. A computer-readable medium having computer-readable instructions executable by a computer according to claim 13, further comprising the step of:
creating a database to store text strings in combination with a representation of the position of the originating dialogue in the asset.

19. A computer-readable medium having computer-readable instructions executable by a computer according to claim 18, further comprising the steps of:
interrogating said database to find instances of a search phrase and their respective positions within the dialogue of said video asset; and
displaying said instances to a user.

20. A computer-readable medium having computer-readable instructions executable by a computer according to claim 13, wherein said representation of the position of the originating dialogue in the asset is in the form of the time at which a given subtitle is displayed within said asset.
